(19) United States
(12) Patent Application Publication
(10) Pub. No.: US 2023/0133911 A1
(43) Pub. Date: May 4, 2023

(54) CHARGE PORT AND SYSTEM FOR AUTOMATED CHARGING OF ELECTRIC VEHICLE

(71) Applicant: Magna Mirrors Holding GmbH, Sailauf (DE)

(72) Inventor: Sethuraman Ravichandran, Aschaffenburg (DE)

(21) Appl. No.: 18/051,131

(22) Filed: Oct. 31, 2022

Related U.S. Application Data
(60) Provisional application No. 63/263,352, filed on Nov. 1, 2021.

(51) Int. Cl. B60L 53/35; B60L 53/16; B60L 53/66; E05F 15/73; B25J 9/16; G01S 5/02

(52) U.S. Cl. CPC B60L 53/35; B25J 9/1694; B60L 53/16; B60L 53/665; E05F 15/73; G01S 5/0295; E05Y 2400/45; E05Y 2400/66; E05Y 2900/534; G06Q 20/18

(57) ABSTRACT

A vehicular electric charging system includes a power charge flap disposed at a vehicle. The power charge flap conceals a charging connector when the power charge flap is in a closed position and reveals a charging connector when the power charge flap is in an open position. A transmitter is disposed at the power charge flap and wirelessly communicates with a receiver disposed within an electric charging wand of a charging station. The charging system, based on communications between the transmitter and the receiver, determines when the electric charging wand enters a flap detection zone. The charging system, based on communications between the transmitter and the receiver, determines when the electric charging wand enters a flap activation zone from the flap detection zone, and, responsive to determining that the electric charging wand enters the flap activation zone, adjusts the power charge flap from the closed position to the open position.

### CROSS REFERENCE TO RELATED APPLICATION

The present application claims the filing benefits of U.S. Provisional Application Ser. No. 63/263,352, filed Nov. 1, 2021, which is hereby incorporated herein by reference in its entirety.

### FIELD OF THE INVENTION

The present invention relates generally to a charging port and charging system for an electric vehicle.

### BACKGROUND OF THE INVENTION

Charging electric vehicles at charging stations by connecting an electrical connector of a charging wand to a charging connector of the electric vehicle is known.

### SUMMARY OF THE INVENTION

A vehicular electric charging system includes a power charge flap or panel disposed on a vehicle equipped with the vehicular electric charging system. The power charge flap conceals a charging connector when the power charge flap is in a closed position. The power charge flap reveals a charging connector when the power charge flap is in an open position. The system includes a transmitter disposed at the power charge flap and an electronic control unit (ECU) including electronic circuitry and associated software. The electronic circuitry of the ECU includes a data processor for processing data for the transmitter. The transmitter wirelessly communicates with a receiver disposed within an electric charging wand. The vehicular electric charging system, based on communications between the transmitter and the receiver, determines when the electric charging wand enters a flap detection zone. The vehicular electric charging system, based on communications between the transmitter and the receiver, determines when the electric charging wand enters a flap activation zone from the flap detection zone. The vehicular electric charging system, responsive to determining that the electric charging wand has entered the flap activation zone, adjusts the power charge flap from the closed position to the open position.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vehicular electric charging system;

FIG. 2 is a schematic view of a flap detection zone and a flap activation zone of the vehicular electric charging system of FIG. 1;

FIG. 3 is a flowchart of example operations for automated charging of an electric vehicle;

FIGS. 4-6 are perspective views of exemplary robotic charging arms charging electric vehicles; and

FIG. 7 is a perspective view of lighting module of the vehicular electric charging system of FIG. 1.

### DESCRIPTION OF THE PREFERRED EMBODIMENTS

A vehicular electric charging system operates to autonomously open and/or close a power charge flap or panel of a vehicle that covers a charging connector configured to electrically connect with an electrical connector of a charging wand to charge the vehicle.

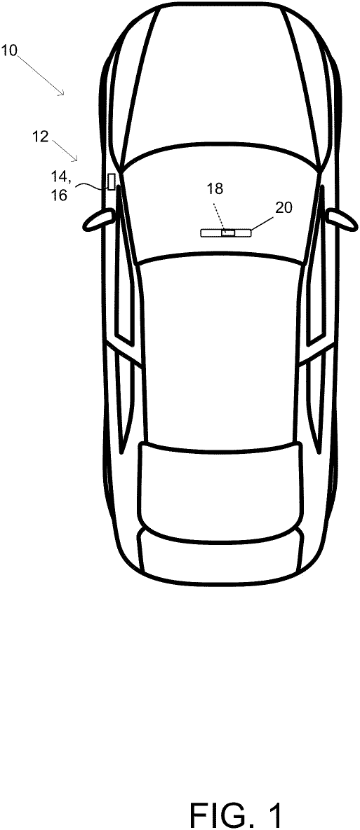

Referring now to FIG. 1, a vehicle 10 includes an electrical charging system 12 that includes a power flap cover 14 (such as a panel that is pivotally mounted at the vehicle and that has an outer surface that, when the panel is in the closed position, corresponds with an outer surface of the exterior panel(s) of the vehicle at and around the charge port of the vehicle). The power flap cover 14, when in a closed position, conceals a charging connector that is configured to electrically connect with an electrical connector or charging wand (of a charging station or system) to charge batteries of the vehicle. When in an open position, the power flap cover 14 reveals the charging connector such that the electrical connector of a charging wand (that is electrically connected to the charging station or system and that is configured for electrically connecting to or plugging into the charging connector of the vehicle) can electrically connect to the charging connector. The power flap cover 14 includes a transceiver and/or transmitter 16. The electric charging system 12 includes a control or electronic control unit (ECU) 18 having electronic circuitry and associated software, with the electronic circuitry including a data processor that is operable to process data for and/or from the transceiver/transmitter 16. The data transfer or signal communication from the transceiver/transmitter to the ECU may comprise any suitable data or communication link, such as a vehicle network bus or the like of the equipped vehicle.

Charging electric vehicles (EVs) generally requires manual connection of the charging station plug that is connected to the station providing the electricity into the charging socket of the EV. Commonly, the charging socket is covered or concealed by a charging flap. Some charging flaps are available with an actuator to power the flap to the open or closed position. These systems are known as power charge flaps (PCFs) and the signal to operate the movement of the PCF typically requires manual intervention of the vehicle user. For example, the PCF may actuate in response to a user input such as a pushing a button (e.g., an “Open Charge Flap” button or the like), in response to direct contact with the PCF, or in response to a user application communicating with the vehicle/PCF via a wireless technology such as BLUETOOTH, near-field communications (NFC), WIFI, etc.

Charging stations generally require payment from the user in order to charge the vehicle. Payment of the electrical charging requires manual operation on behalf of the vehicle operator (e.g. insertion of a payment card into the charging station or connection to the station via an application executing on, for example, a mobile device of the user). Additionally, securing automatic payments using a wireless technology (e.g., BLUETOOTH) is a pressing concern.

Implementations herein include a system providing a passive way of charging electric vehicles assisted by ultra-wideband (UWB) time of flight distance measurements (which may be made via processing of data captured by one or more time of flight sensors and/or transmitters disposed at the vehicle charge port and/or sensing or communicating with the charging wand). A communication gateway in communication with a PCF automatically establishes a connection with the charging station the EV is parked at. This automates the process of charging the vehicles (i.e., reduces or eliminates human intervention when charging an electric vehicle). The system allows for the automated charging station plug of the charging station (e.g., a robotic charger or robotic charging arm) to be guided to the charging socket of the EV using range and vector communication supplied by a UWB antenna system (e.g., the transmitter/transceiver 16 of FIG. 1).

The system may be based on UWB time of flight principles. For example, based on zones, the system establishes two-way communication between the PCF and the charging station. The system ensures the automatic opening/closing of the PCF (i.e., the flap) and pairing with a robot charger and processing payment once the vehicle is parked in the charging station. This may be accomplished by integrating a universal transmitter in the PCF and the universal receiver on the charging gun.

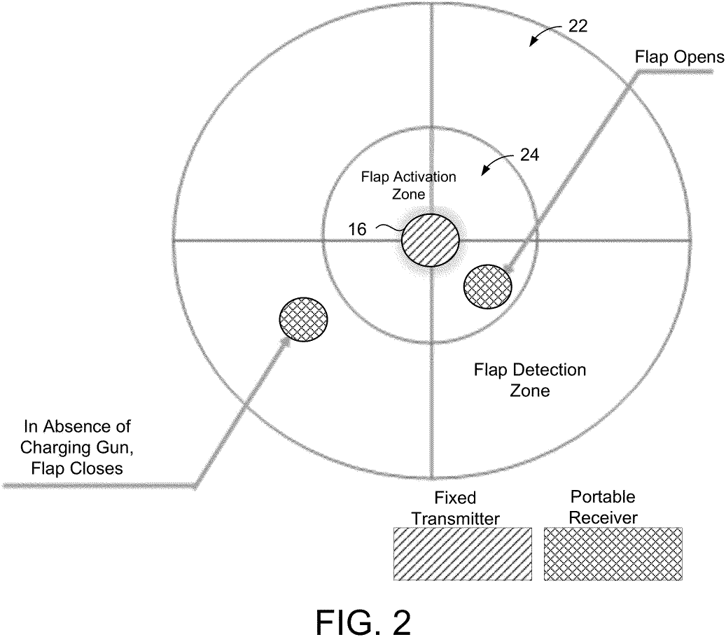

Referring now to FIG. 2, the PCF may include a fixed transmitter (i.e., disposed at or near the flap), such as the transmitter 16 (FIG. 1), that communicates with a portable receiver disposed at or near an end of the charging wand/gun. Based on communications between the transmitter and the receiver, the PCF determines whether the charger enters a flap activation zone 24 (i.e., a zone where the flap activates) from a flap detection zone 22 (i.e., a wand detection zone or a zone where the system detects the wand) or leaves the flap activation zone 24 into the flap detection zone 22. That is, the PCF determines when the charging wand transitions from the flap detection zone 22 to the flap activation zone 24 (i.e., by moving closer to the transmitter 16) and when the charging wand transitions from the flap activation zone 24 to the flap detection zone 22 (i.e., by moving away from the transmitter 16). When the charger enters the flap activation zone, the PCF (i.e., the flap) may open, thereby exposing the charging connector of the vehicle to the charging wand. Similarly, when the charging wand exits the flap activation zone, the flap may close. The flap activation zone may be a zone in close proximity to the PCF, while the flap detection zone extends beyond the flap activation zone (as shown in FIG. 2, the radius/size of the flap detection zone is larger than the radius/size of the flap activation zone), such that the charging wand must pass through the flap detection zone to enter the flap activation zone. The flap activation zone and the wand detection zone may cooperate to allow for a configurable flap activation zone size, help reduce false positives (e.g., by allowing for hysteresis and the like), better track the wand, etc. The charging system may communicate messages to and from a battery management system of the vehicle or other vehicle ECU. For example, the charging system may communicate with the battery management system to provide information or data pertaining to the charging of the vehicle battery (e.g., charge level, time to charge, etc.)

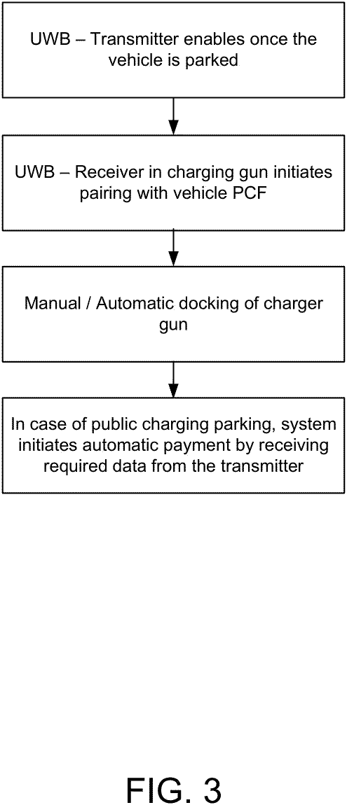

As shown in FIG. 3, in an example scenario, once the equipped vehicle is parked at a charging station not equipped with a robotic arm charger (i.e., a charger capable of autonomously moving the charging wand to the vehicle to connect with the charging connector of the vehicle), the driver brings the charging connector/gun toward or away from a flap activation zone of the PCF, the flap opens/closes respectively. In case of a public charging station, payment may be carried out automatically after successful starting or finishing charging.

In another example scenario, in the case of a modern parking station equipped with a robotic arm charger (i.e., a charger capable of autonomously moving the charging wand), the PCF of the EV may open automatically. Then, the charging arm/robot may determine the exact coordinates of the PCF of the vehicle, and based on the coordinates, dock with the charging receptacle of the vehicle. The charging station then recharges the battery of the vehicle and initiates secure payment (e.g., at the end of charging). For example, the vehicle stores (e.g., at non-volatile memory such as flash memory within the vehicle or via remote storage accessed by the vehicle wirelessly) user configuration and/or profile information, such as user-defined charging limits, charging rates, billing/payment information, subscription information, etc. In some examples, the system may only request charging (e.g., via the transmitter) when the battery is below a predefined threshold. For example, when the vehicle is parked at a charging station and the system determines that the current battery charge is below the predefined threshold (e.g., fifty percent), the system sends a charging to request to the charging station to initiate automated charging. A user may configure the predefined threshold (i.e., a user may set the charging threshold to a different value, such as sixty percent or thirty percent or any desired or selected threshold at which the user wants the vehicle battery recharged).

Optionally, the electric charging station must be enabled by a user of the vehicle prior to use. For example, a user of the vehicle enables the automatic opening/closing of the PCF via configuration controls accessed via the vehicle and/or a user device (e.g., a mobile phone). The user may constrain when the system is enabled (e.g., only during certain hours, only when the vehicle is located at certain locations, etc.). The user may access the system via controls in the vehicle and/or remotely using wireless communication (e.g., via a user device such as a mobile phone). In some examples, the system is only enabled when the vehicle is at a location where it is known a charger exists. For example, using a GPS sensor or the like, the vehicle determines that the vehicle is located at a charging station prior to enabling automatic opening/closing of the PCF based on detecting the portable receiver of the charging wand. In some examples, the portable receiver of the charging wand must be “paired” with the fixed transmitter of the PCF before the PCF will respond to the charging wand. For example, a user may pair and authorize a particular charging station/wand during a first use, and during subsequent uses, the PCF will “recognize” (e.g., via cryptographic authentication) the paired charging wand and open/close automatically. The user may have to set up an account with the charging station (e.g., including billing details) before pairing is allowed.

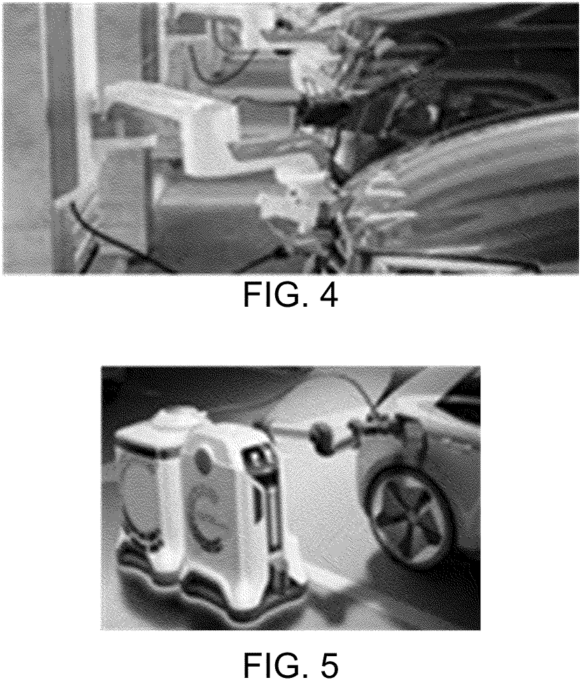

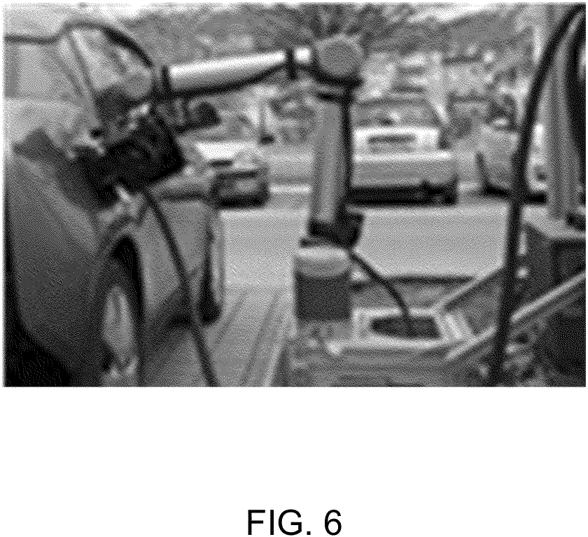

Referring now to FIGS. 4-6, the system provides precise location capabilities to guide the robotic charger plug/station to the EVs charge socket. Thus, the system reduces the complexity of charging EVs and the amount of manual operations required is minimized. Automating the opening/closing of the flap and connection to the charging station is possible and secure data connection/communication to the charging station allows automatic payment.

The system thus may utilize one or more (e.g., one, two, or three) time of flight sensors or transmitters (or other suitable sensors) at the charge port to determine presence of the charging wand (e.g., via communication between the transmitter and a receiver at the charging wand) as it enters the flap detection zone (e.g., via triangulation). The system (via processing of sensor data captured by the one or more time of flight sensors or other sensors or via communication between the transmitter and the receiver) continues to monitor or track the charging wand as it moves through the flap detection zone into the flap activation zone. When the system determines that the charging wand has entered the flap activation zone, the system opens the flap to allow the charging wand to electrically connect to the charge port of the vehicle. Because the system monitors and tracks the location of the charging wand relative to the charge port, the system may communicate the relative location to the charging system, whereby the charging system (if automated) may robotically move the charging wand to electrically connect the charging wand to the charge port of the vehicle. Optionally, the charging system may determine, based on communications between the transmitter(s) and receiver(s), the location of the charging wand relative to the power charge flap, and adjust position of the charging wand accordingly. Optionally, the system may triangulate the location of the charging wand relative to the power charge flap by utilizing multiple time of flight transmitters or sensors at or near the charge port.

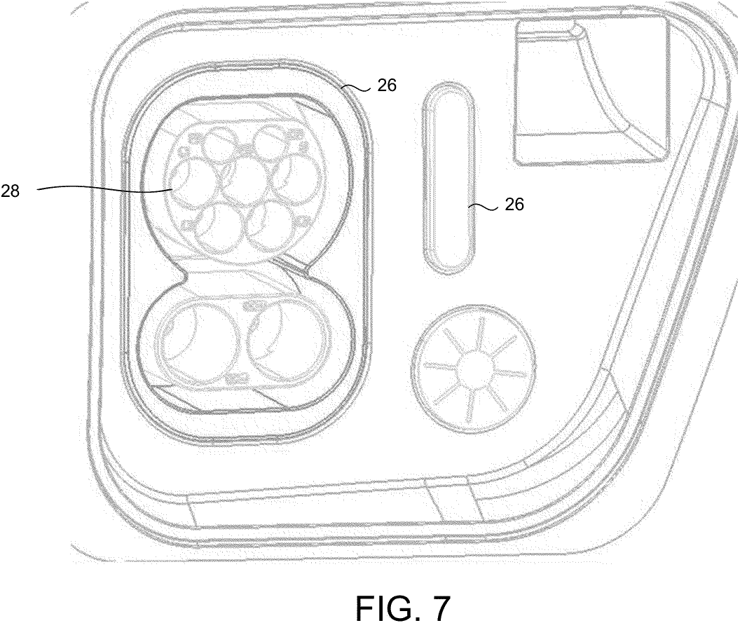

Referring now to FIG. 7, the system may include one or more light or lighting modules 26 to notify a user of charging status, provide warning indications, provide battery level indications, and/or to provide illumination (e.g., pocket lighting). For example, the lighting module may illuminate the charging socket 28 during manual charging in low-light conditions. The lighting module may emit multiple different color lights using multiple patterns (e.g., solid, slow blinking, fast blinking, etc.) to indicate different notifications. For example, a blinking green light may indicate the charger is charging the vehicle while a solid green light indicates that charging is complete.

The vehicle may include any type of sensor or sensors at the charge port, such as imaging sensors or radar sensors or lidar sensors or ultrasonic sensors or the like. The sensors may comprise radar or lidar sensors or the like, and the sensing system may utilize aspects of the systems described in U.S. Pat. Nos. 9,753,121; 9,689,967; 9,599,702; 9,575,160; 9,146,898; 9,036,026; 8,027,029; 8,013,780; 7,053,357; 7,408,627; 7,405,812; 7,379,163; 7,379,100; 7,375,803; 7,352,454; 7,340,077; 7,321,111; 7,310,431; 7,283,213; 7,212,663; 7,203,356; 7,176,438; 7,157,685; 6,919,549; 6,906,793; 6,876,775; 6,710,770; 6,690,354; 6,678,039; 6,674,895 and/or 6,587,186, and/or U.S. Publication Nos. US-2019-0339382; US-2018-0231635; US-2018-0045812; US-2018-0015875; US-2017-0356994; US-2017-0315231; US-2017-0276788; US-2017-0254873; US-2017-0222311 and/or US-2010-0245066, which are hereby incorporated herein by reference in their entireties.

The sensing system may utilize an imaging sensor or camera that may capture image data for image processing and may comprise any suitable camera or sensing device, such as, for example, a two dimensional array of a plurality of photosensor elements arranged in at least 640 columns and 480 rows (at least a 640 x 480 imaging array, such as a megapixel imaging array or the like), with a respective lens focusing images onto respective portions of the array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or pixels arranged in rows and columns. The imaging array may capture color image data, such as via spectral filtering at the array, such as via an RGB (red, green and blue) filter or via a red / red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

The system may also communicate with other systems, such as via a vehicle-to-vehicle communication system or a vehicle-to-infrastructure communication system or the like. Such car2car or vehicle to vehicle (V2V) and vehicle-to-infrastructure (car2X or V2X or V2I or a 4G or 5G broadband cellular network) technology provides for communication between vehicles and/or infrastructure based on information provided by one or more vehicles and/or information provided by a remote server or the like. Such vehicle communication systems may utilize aspects of the systems described in U.S. Pat. Nos. 10,819,943; 9,555,736; 6,690,268; 6,693,517 and/or 7,580,795, and/or U.S. Publication Nos. US-2014-0375476; US-2014-0218529; US-2013-0222592; US-2012-0218412; US-2012-0062743; US-2015-0251599; US-2015-0158499; US-2015-0124096; US-2015-0352953; US-2016-0036917 and/or US-2016-0210853, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular electric charging system, the vehicular electric charging system comprising:
a power charge flap disposed at a vehicle equipped with the vehicular electric charging system, wherein the power charge flap conceals a charging connector from the external environment of the vehicle when the power charge flap is in a closed position, and wherein the power charge flap reveals the charging connector to the external environment of the vehicle when the power charge flap is in an open position;
a transmitter disposed at the power charge flap;
an electronic control unit (ECU) comprising electronic circuitry and associated software;
wherein the electronic circuitry of the ECU comprises a data processor for processing data for the transmitter;
wherein the transmitter wirelessly communicates with a receiver disposed within an electric charging wand of an electric vehicle charging station;
wherein the vehicular electric charging system, based on communications between the transmitter and the receiver, determines when the electric charging wand enters a wand detection zone within a first threshold distance from the transmitter;
wherein the vehicular electric charging system, based on communications between the transmitter and the receiver, determines when the electric charging wand enters a flap activation zone within a second threshold distance from the transmitter, and wherein the second threshold distance is closer to the transmitter than the first threshold distance, and wherein the electric charging wand enters the flap activation zone from the wand detection zone; and
wherein the vehicular electric charging system, responsive to determining, based on communications between the transmitter and the receiver, that the electric charging wand enters the flap activation zone from the wand detection zone, adjusts the power charge flap from the closed position to the open position.

2. The vehicular electric charging system of claim 1, wherein the vehicular electric charging system, based on communications between the transmitter and the receiver, determines when the electric charging wand enters the wand detection zone from the flap activation zone, and wherein the vehicular electric charging system, responsive to determining that the electric charging wand enters the wand detection zone from the flap activation zone, adjusts the power charge flap from the open position to the closed position.

3. The vehicular electric charging system of claim 1, wherein the transmitter comprises an ultra-wideband transmitter.

4. The vehicular electric charging system of claim 1, wherein the transmitter comprises a universal transmitter.

5. The vehicular electric charging system of claim 1, wherein the vehicular electric charging system, responsive to determining the equipped vehicle is parked at the electric vehicle charging station, enables the transmitter.

6. The vehicular electric charging system of claim 1, wherein the electric charging wand is disposed on a robotic charging arm, and wherein the robotic charging arm autonomously maneuvers the electric charging wand.

7. The vehicular electric charging system of claim 6, wherein the electric charging wand comprises an electrical connector configured to electrically connect to the charging connector, and wherein the robotic charging arm, when the power charge flap is in the open position, maneuvers the electric charging wand to electrically connect the electrical connector and the charging connector.

8. The vehicular electric charging system of claim 7, wherein the robotic charging arm maneuvers the electric charging wand based on communications between the transmitter and the receiver.

9. The vehicular electric charging system of claim 8, wherein the robotic charging arm, based on the communications between the transmitter and the receiver, determines a position of the electric charging wand relative to the power charge flap, and wherein the robotic charging arm, responsive to determining the position of the electric charging wand relative to the power charge flap, maneuvers the electric charging wand.

10. The vehicular electric charging system of claim 9, comprising a second transmitter, and wherein the robotic charging arm maneuvers the electric charging wand based on the communications between the transmitter and the receiver and based on communications between the second transmitter and the receiver.

11. The vehicular electric charging system of claim 1, wherein the vehicular electric charging system, responsive to determining that charging of the vehicle is completed, automatically processes a payment for the charging.

12. The vehicular electric charging system of claim 1, wherein the vehicular electric charging system determines that the electric charging wand enters the flap activation zone based on time of flight of the communications between the transmitter and the receiver.

13. The vehicular electric charging system of claim 12, wherein the vehicular electric charging system, based on the time of flight of the communications, determines a distance between the transmitter and the receiver.

14. A vehicular electric charging system, the vehicular electric charging system comprising:
a power charge flap disposed at a vehicle equipped with the vehicular electric charging system, wherein the power charge flap conceals a charging connector from the external environment of the vehicle when the power charge flap is in a closed position, and wherein the power charge flap reveals the charging connector to the external environment of the vehicle when the power charge flap is in an open position;
a transmitter disposed at the power charge flap;
wherein the vehicular electric charging system, responsive to determining the equipped vehicle is parked at an electric vehicle charging station, enables the transmitter;
an electronic control unit (ECU) comprising electronic circuitry and associated software;
wherein the electronic circuitry of the ECU comprises a data processor for processing data for the transmitter;
wherein the transmitter wirelessly communicates with a receiver disposed within an electric charging wand of the electric vehicle charging station;
wherein the vehicular electric charging system, based on communications between the transmitter and the receiver, determines when the electric charging wand enters a wand detection zone within a first threshold distance from the transmitter;
wherein the vehicular electric charging system, based on communications between the transmitter and the receiver, determines when the electric charging wand enters a flap activation zone within a second threshold distance from the transmitter, and wherein the second threshold distance is closer to the transmitter than the first threshold distance, and wherein the electric charging wand enters the flap activation zone from the wand detection zone;
wherein the vehicular electric charging system, responsive to determining, based on communications between the transmitter and the receiver, that the electric charging wand enters the flap activation zone from the wand detection zone, adjusts the power charge flap from the closed position to the open position; and
wherein the vehicular electric charging system, responsive to determining, based on communications between the transmitter and the receiver, when the electric charging wand exits the flap activation zone to the wand detection zone, adjusts the power charge flap from the open position to the closed position.

15. The vehicular electric charging system of claim 14, wherein the electric charging wand is disposed on a robotic charging arm, and wherein the robotic charging arm autonomously maneuvers the electric charging wand.

16. The vehicular electric charging system of claim 15, wherein the electric charging wand comprises an electrical connector configured to electrically connect to the charging connector, and wherein the robotic charging arm, when the power charge flap is in the open position, maneuvers the electric charging wand to electrically connect the electrical connector and the charging connector.

17. The vehicular electric charging system of claim 16, wherein the robotic charging arm maneuvers the electric charging wand based on communications between the transmitter and the receiver.

18. The vehicular electric charging system of claim 17, wherein the robotic charging arm, based on the communications between the transmitter and the receiver, determines a position of the electric charging wand relative to the power charge flap, and wherein the robotic charging arm, responsive to determining the position of the electric charging wand relative to the power charge flap, maneuvers the electric charging wand.

19. The vehicular electric charging system of claim 18, comprising a second transmitter, and wherein the robotic charging arm maneuvers the electric charging wand based on the communications between the transmitter and the receiver and based on communications between the second transmitter and the receiver.

20. The vehicular electric charging system of claim 14, wherein the vehicular electric charging system, responsive to determining that charging of the vehicle is completed, automatically processes a payment for the charging.

21. A vehicular electric charging system, the vehicular electric charging system comprising:
a power charge flap disposed at a vehicle equipped with the vehicular electric charging system, wherein the power charge flap conceals a charging connector from the external environment of the vehicle when the power charge flap is in a closed position, and wherein the power charge flap reveals the charging connector to the external environment of the vehicle when the power charge flap is in an open position;
a transmitter disposed at the power charge flap;
wherein the vehicular electric charging system, responsive to determining the equipped vehicle is parked at an electric vehicle charging station, enables the transmitter;
an electronic control unit (ECU) comprising electronic circuitry and associated software;
wherein the electronic circuitry of the ECU comprises a data processor for processing data for the transmitter;
wherein the transmitter wirelessly communicates with a receiver disposed within an electric charging wand of the electric vehicle charging station;
wherein the electric charging wand is disposed on a robotic charging arm, and wherein the robotic charging arm autonomously maneuvers the electric charging wand;
wherein the vehicular electric charging system, based on communications between the transmitter and the receiver, determines when the electric charging wand enters a wand detection zone within a first threshold distance from the transmitter;
wherein the vehicular electric charging system, based on communications between the transmitter and the receiver, determines when the electric charging wand enters a flap activation zone within a second threshold distance from the transmitter, and wherein the second threshold distance is closer to the transmitter than the first threshold distance, and wherein the electric charging wand enters the flap activation zone from the wand detection zone;
wherein the vehicular electric charging system, responsive to determining, based on communications between the transmitter and the receiver, that the electric charging wand enters the flap activation zone from the wand detection zone, adjusts the power charge flap from the closed position to the open position; and
wherein the robotic charging arm, based on the communications between the transmitter and the receiver, determines a position of the electric charging wand relative to the power charge flap, and wherein the robotic charging arm, responsive to determining the position of the electric charging wand relative to the power charge flap, maneuvers the electric charging wand.

22. The vehicular electric charging system of claim 21, wherein the electric charging wand comprises an electrical connector configured to electrically connect to the charging connector, and wherein the robotic charging arm, when the power charge flap is in the open position, maneuvers the electric charging wand to electrically connect the electrical connector and the charging connector.

23. The vehicular electric charging system of claim 21, comprising a second transmitter, and wherein the robotic charging arm maneuvers the electric charging wand based on the communications between the transmitter and the receiver and based on communications between the second transmitter and the receiver.

24. The vehicular electric charging system of claim 21, wherein the vehicular electric charging system, responsive to determining that charging of the vehicle is completed, automatically processes a payment for the charging.
